(19) United States
(12) Patent Application Publication
(10) Pub. No.: US 2026/0058049 A1
(43) Pub. Date: Feb. 26, 2026

(54) COIL COMPONENT

(71) Applicant: SAMSUNG ELECTRO-MECHANICS CO., LTD., Suwon-si (KR)

(72) Inventors: Dong Gun LEE, Suwon-si (KR); Joung Hee CHO, Suwon-si (KR); Dong Hwi AHN, Suwon-si (KR)

(73) Assignee: SAMSUNG ELECTRO-MECHANICS CO., LTD., Suwon-si (KR)

(21) Appl. No.: 19/202,375

(22) Filed: May 8, 2025

(30) Foreign Application Priority Data
Aug. 21, 2024 (KR) 10-2024-0112172
Dec. 31, 2024 (KR) 10-2024-0201608

(51) Int. Cl. H01F 27/29; H01F 5/04

(52) U.S. Cl. CPC H01F 27/292; H01F 5/04

(57) ABSTRACT

A coil component includes a body including a first surface and a second surface opposing each other in a first direction, and a third surface and a fourth surface opposing each other in a second direction, perpendicular to the first direction, a coil including a winding portion disposed in the body, and a lead-out portion extending from an end of the winding portion onto the body, and an external electrode disposed on the body, the external electrode having an internal surface facing the body and an external surface opposing the internal surface. The external electrode includes at least one protrusion portion protruding from the internal surface toward the body, and the lead-out portion is in contact with the internal surface of the external electrode.

### CROSS-REFERENCE TO RELATED APPLICATION(S)

This application claims benefit of priority to Korean Patent Application Nos. 10-2024-0112172, filed on Aug. 21, 2024, and 10-2024-0201608, filed on Dec. 31, 2024 in the Korean Intellectual Property Office, the disclosure of which is incorporated herein by reference in its entirety.

### TECHNICAL FIELD

The present disclosure relates to a coil component.

An inductor, a coil component, is a representative passive electronic component used in electronic devices, along with a resistor and a capacitor. A coil may allow the flow of current to be adjusted, removing noise and preventing sudden changes in current, thereby protecting electronic devices.

As electronic devices have gradually higher performance and reduced sizes, electronic components used in electronic devices have increased in number and reduced in size.

As the number of electronic devices used in vehicles increases, in particular, the number of electronic devices directly mounted in an engine room, there is demand for inductors having enhanced vibration resistance.
Patent Document 1: KR Patent Application Publication No. 10-2017-0085895

### SUMMARY

An aspect of the present disclosure is to provide a coil component having improved vibration resistance by reinforcing a fillet formed by solder, when mounted on a board, through a protrusion portion formed on a base portion of an external electrode, the protrusion portion accommodating Sn.

Another aspect of the present disclosure is to provide a coil component having enhanced mounting strength, when mounted on a board, through a protrusion portion formed on a pad portion of an external electrode.

Another aspect of the present disclosure is to guide a position of a lead-out portion through a plurality of protrusion portions formed on an external electrode.

Another aspect of the present disclosure is to prevent the movement of an external electrode by allowing a body and the external electrode to have a predetermined distance therebetween through a plurality of protrusion portions formed on the external electrode.

According to an aspect of the present disclosure, there is provided a coil component including a body including a first surface and a second surface opposing each other in a first direction, and a third surface and a fourth surface opposing each other in a second direction, perpendicular to the first direction, a coil including a winding portion disposed in the body, and a lead-out portion extending from an end of the winding portion onto the body, and an external electrode disposed on the body, the external electrode having an internal surface facing the body and an external surface opposing the internal surface. The external electrode may include at least one protrusion portion protruding from the internal surface toward the body, and the lead-out portion may be in contact with the internal surface of the external electrode.

According to another aspect of the present disclosure, there is provided a coil component including a body, a coil disposed in the body, the coil including a lead-out portion, and an external electrode disposed on the body, the external electrode connected to the lead-out portion, the external electrode including a plurality of protrusion portions. The lead-out portion may be disposed between protrusion portions, adjacent to each other, among the plurality of protrusion portions.

According to some example embodiments of the present disclosure, a protrusion portion formed on a base portion of an external electrode of a coil component may include Sn. Thus, the coil component may have improved vibration resistance by reinforcing a fillet formed by solder, when mounted on a board.

According to some example embodiments of the present disclosure, a coil component may have enhanced mounting strength, when mounted on a board, through a protrusion portion formed on a pad portion of an external electrode.

According to some example embodiments of the present disclosure, a position of a lead-out portion may be guided through a plurality of protrusion portions formed on an external electrode.

According to some example embodiments of the present disclosure, a body and an external electrode may be allowed to have a predetermined distance therebetween through a plurality of protrusion portions formed on the external electrode, thereby the movement of the external electrode.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a schematic perspective view of a coil component according to a first example embodiment of the present disclosure;

FIG. 2 is a cross-sectional view taken along line I-I′ of FIG. 1;

FIG. 3 is an enlarged view of region “A” of FIG. 2;

FIG. 4 is an enlarged view of region “B” of FIG. 2;

FIG. 5 is a partial cross-sectional view taken along line II-II′ of FIG. 1;

FIG. 6 is a schematic diagram illustrating a process of forming a coil and an external electrode of a coil component according to a second example embodiment of the present disclosure;

FIG. 7 is an exploded perspective view of FIG. 1, and illustrates a form of the external electrode before bending;

FIGS. 8 to 11 are diagrams illustrating modifications of a cross-sectional shape of the protrusion portion of FIG. 5;

FIG. 12 is a diagram illustrating a lead-out portion and an external electrode of a coil component according to a second example embodiment of the present disclosure;

FIG. 13 is a diagram illustrating a lead-out portion and an external electrode of a coil component according to a third example embodiment of the present disclosure;

FIG. 14 is a diagram illustrating a lead-out portion and an external electrode of a coil component according to a fourth example embodiment of the present disclosure;

FIG. 15 is a schematic perspective view of a coil component according to a fifth example embodiment of the present disclosure;

FIG. 16 is a cross-sectional view taken along line III-III′ of FIG. 15;

FIG. 17 is a diagram illustrating a lead-out portion and an external electrode of a coil component according to a sixth example embodiment of the present disclosure;

FIG. 18 is a diagram illustrating a lead-out portion and an external electrode of a coil component according to a seventh example embodiment of the present disclosure;

FIG. 19 is a schematic diagram illustrating a form in which a fillet is formed when a coil component in which a protrusion portion is omitted from FIG. 1 is mounted on a board;

FIG. 20 is a schematic diagram illustrating a form in which a fillet is reinforced when the coil component of FIG. 1 is mounted on a board;

FIG. 21 is an experimental example illustrating a form in which a fillet is formed when a coil component not including a protrusion portion is mounted on a board;

FIG. 22 is an experimental example illustrating a form in which a fillet is formed when a coil component including a protrusion portion is mounted on a board; and

FIG. 23 is an example illustrating a simulation result of a stress change according to fillet formation and fillet reinforcement.

### DETAILED DESCRIPTION

Terminology used herein is for the purpose of describing particular example embodiments only and is not to be limiting of the example embodiments. As used herein, the singular forms “a,” “an,” and “the” are intended to include the plural forms as well, unless the context clearly indicates otherwise. As used herein, the term “and/or” includes any one and any combination of any two or more of the associated listed items. It will be further understood that the terms “comprises” and/or “comprising,” when used in this specification, specify the presence of stated features, integers, steps, operations, elements, components or a combination thereof, but do not preclude the presence or addition of one or more other features, integers, steps, operations, elements, components, and/or groups thereof. In addition, the terms “disposed on,” “positioned on,” and the like, may mean the element is positioned on or below a target portion, and does not necessarily mean that the element is positioned on an upper side of the target portion with respect to a direction of gravity.

The terms “coupled to,” “connected to,” and the like, may not only indicate that elements are directly and physically in contact with each other, but also include a configuration in which another element is interposed between the elements such that the elements are also in contact with the other element.

The size and thickness of each element illustrated in the drawings is arbitrarily represented for ease of the description, but the present disclosure is not limited to those illustrated herein.

In the drawings, an L-direction may be defined as a first direction or a length direction, a T-direction may be defined as a second direction or a thickness direction, and a W-direction may be defined as a third direction or a width direction.

Hereinafter, a coil component according to some example embodiments of the present disclosure will be described in detail with reference to the accompanying drawings. In the description with reference to the accompanying drawings, the same or corresponding elements are denoted by the same reference numerals and repeated descriptions thereof will be omitted.

Various types of electronic components may be used in electronic devices, and various types of coil components may be appropriately used between such electronic components to remove noise.

That is, in an electronic device, a coil component may be used as a power inductor, a high frequency (HF) inductor, a general bead, a high-frequency bead (GHz bead), a common mode filter, or the like.

### First Example Embodiment

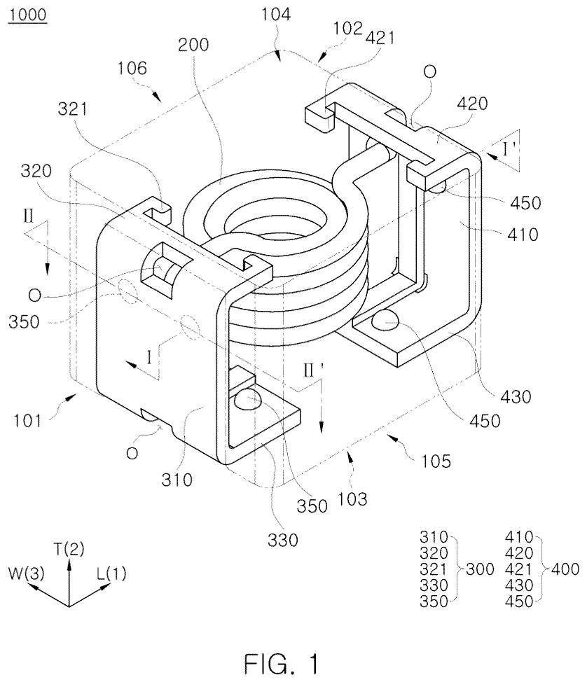

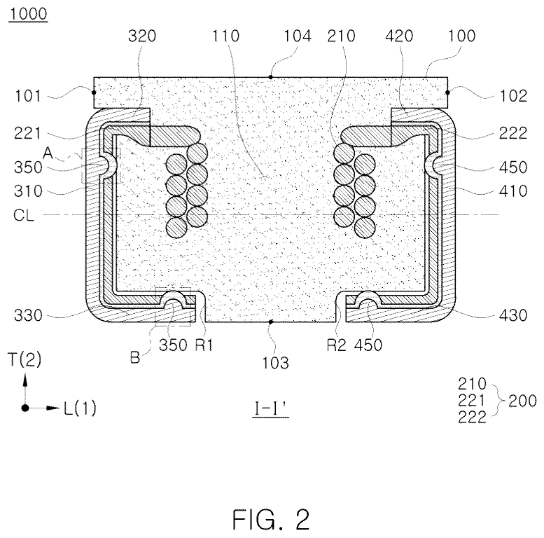

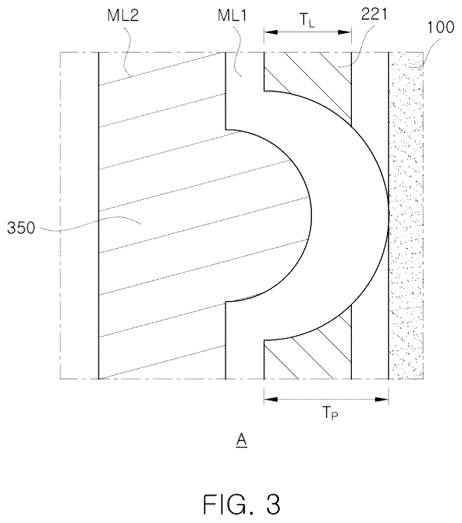

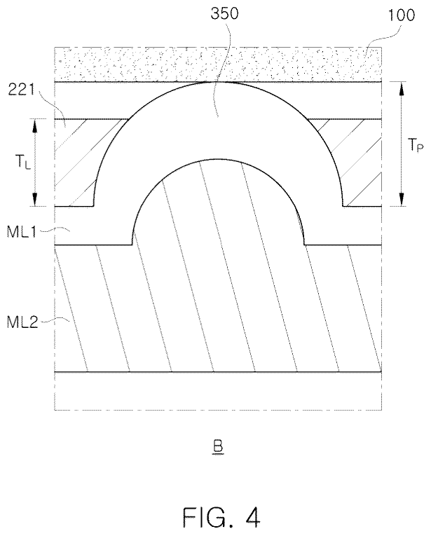

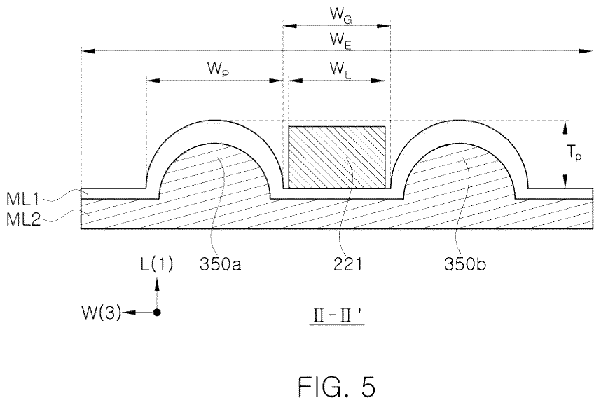

FIG. 1 is a schematic perspective view of a coil component according to a first example embodiment of the present disclosure. FIG. 2 is a cross-sectional view taken along line I-I′ of FIG. 1. FIG. 3 is an enlarged view of region “A” of FIG. 2. FIG. 4 is an enlarged view of region “B” of FIG. 2. FIG. 5 is a partial cross-sectional view taken along line II-II′ of FIG. 1.

In FIG. 1, the body 100 is illustrated in a transparent manner to clearly represent an arrangement relationship between elements.

Referring to FIGS. 1 to 5, a coil component 1000 according to a first example embodiment of the present disclosure may include a body 100, a coil 200, and first and second external electrodes 300 and 400, and the first and second external electrodes 300 and 400 may include at least one protrusion portion 350 and at least one protrusion 450 protruding toward the body 100, respectively. The protrusion portions 350 and 450 may be formed on base portions 310 and 410 of the external electrodes 300 and 400, facing a side surface of the body 100, and/or pad portions 330 and 430 of the external electrodes 300 and 400, respectively, facing a lower surface of the body 100.

The protrusion portions 350 and 450 may include a first metal layer ML1 protruding toward the body 100, and a second metal layer ML2 filling a recessed region formed on an external surface of the first metal layer ML1. The second metal layer ML2 may include Sn. Due to the above-described structure, during a reflow process of mounting the coil component 1000 on a board, the second metal layer ML2 in the protrusion portions 350 and 450, formed on the base portions 310 and 410, may flow downwardly, thereby reinforcing a fillet by solder. The reinforced fillet may enhance bonding force between the board and the coil component 1000 by relieving stress applied to the coil component 1000, and consequently, improve impact resistance and vibration resistance of the coil component 1000.

In addition, the lead-out portions 221 and 222 at both ends of the coil 200 may be disposed between the body 100 and the external electrodes 300 and 400 to be in contact with internal surfaces of the external electrodes 300 and 400, respectively, and may be disposed between a pair of protrusion portions 350a and 350b and a pair of protrusion portions 450a and 450b formed on the internal surfaces of the external electrodes 300 and 400. Accordingly, positions of the lead-out portions 221 and 222 may be guided due to the lead-out portions 221 and 222 disposed between the pair of adjacent protrusion portions 350a and 350b, and the pair of adjacent protrusion portions 450a and 450b formed on the internal surfaces of the external electrodes 300 and 400.

Hereinafter, main elements included in the coil component 1000 according to the present example embodiments will be described in detail.

The body 100 may form the exterior of the coil component 1000 according to the present example embodiments, and may include the coil 300 buried therein.

The body 100 may have an overall hexahedral shape.

The body 100 may have a first surface 101 and a second surface 102 opposing each other in a length direction L (first direction), a third surface 103 and a fourth surface 104 opposing each other in a thickness direction T (second direction), and a fifth surface 105 and a sixth surface 106 opposing each other in a width direction W (third direction). Each of the first surface 101, the second surface 102, the fifth surface 105, and the sixth surface 106 of the body 100 may correspond to a wall surface of the body 100 connecting the third surface 103 and the fourth surface 104 to each other.

For example, the body 100 may be formed such that the coil component 1000 according to the present example embodiments, including the external electrodes 400 and 500, has a length of 6.47 mm, a width of 6.47 mm, and a thickness of 2.8 mm, and has a length of 5.2 mm, a width of 5.2 mm, and a thickness of 2.8 mm. The above-described dimensions refer to dimensions not reflecting process variations. Accordingly, any dimensions that fall within a range recognized as manufacturing tolerances should be considered as corresponding to the above-described exemplary dimensions.

With respect to an optical microscope or scanning electron microscope (SEM) image of a cross-section in the length direction L and the thickness direction T obtained by cutting a central portion of the coil component 1000 in the width direction W, the above-described length of the coil component 1000 may refer to a maximum value among dimensions of a plurality of line segments connecting, to each other, two outermost boundary lines of the coil component 1000 opposing each other in the length direction L illustrated in the image, to be parallel to the length direction L, the plurality of line segments spaced apart from each other in the thickness direction T. Alternately, the above-described length of the coil component 1000 may refer to a minimum value among the dimensions of the plurality of line segments. Alternately, the above-described length of the coil component 1000 may refer to an arithmetic mean value of at least three dimensions among the dimensions of the plurality of segments. Here, the plurality of line segments, parallel to the length direction L, may be equally spaced from each other in the thickness direction T, but the present disclosure is not limited thereto.

With respect to the optical microscope or SEM image of the cross-section in the length direction L and the thickness direction T obtained by cutting the central portion of the coil component 1000 in the width direction W, the above-described thickness of the coil component 1000 may refer to a maximum value among dimensions of a plurality of line segments connecting, to each other, two outermost boundary lines of the coil component 1000 opposing each other in the thickness direction T illustrated in the image, to be parallel to the thickness direction T, the plurality of line segments spaced apart from each other in the length direction L. Alternately, the above-described thickness of the coil component 1000 may refer to a minimum value among the dimensions of the plurality of line segments. Alternately, the above-described thickness of the coil component 1000 may refer to an arithmetic mean value of at least three dimensions among the dimensions of the plurality of segments. Here, the plurality of line segments, parallel to the thickness direction T, may be equally spaced from each other in the length direction L, but the present disclosure is not limited thereto.

With respect to an optical microscope or SEM image of a cross-section in the length direction L and the width direction W obtained by cutting a central portion of the coil component 1000 in the thickness direction T, the above-described width of the coil component 1000 may refer to a maximum value among dimensions of a plurality of line segments connecting, to each other, two outermost boundary lines of the coil component 1000 opposing each other in the width direction W illustrated in the image, to be parallel to the width direction W, the plurality of line segments spaced apart from each other in the length direction L. Alternately, the above-described width of the coil component 1000 may refer to a minimum value among the dimensions of the plurality of line segments. Alternately, the above-described width of the coil component 1000 may refer to an arithmetic mean value of at least three dimensions among the dimensions of the plurality of segments. Here, the plurality of line segments, parallel to the width direction W, may be equally spaced apart from each other in the length direction L, but the present disclosure is not limited thereto.

Alternatively, each of the length, width, and thickness of the coil component 1000 may be measured by a micrometer measurement method. Each of the length, width, and thickness of the coil component 1000 may be measured using the micrometer measurement method by setting a zero point with a gage repeatability and reproducibility (R & R) micrometer, inserting the coil component 1000 according to the present example embodiments into a tip of the micrometer, and turning a measurement lever of the micrometer. In measuring the length of the coil component 1000 using the micrometer measurement method, the length of the coil component 1000 may refer to a value measured once or an arithmetic mean of values measured multiple times, which may be applied to the width and thickness of the coil component 1000 in the same manner.

The body 100 may include a magnetic material and a resin. The body 100 may be formed by filling a mold with a magnetic material, and may be formed by filling the mold with a composite material including a magnetic material and a resin. A molding process of applying high temperature and high pressure to a magnetic material or a composite material in a mold may be additionally performed, but the present disclosure is not limited thereto.

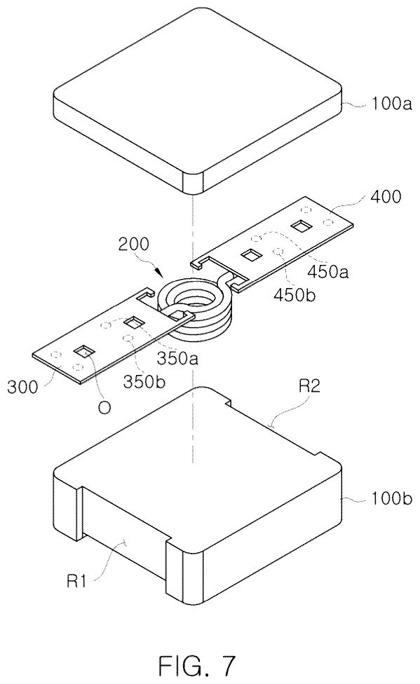

Referring to FIG. 7, in the body 100, for example, bodies 100a and 100b, two upper and lower regions of the coil 200, may be separately formed, and may be coupled to each other to form a single body 100. In this case, the bodies 100a and 100b, the two upper and lower regions, may have different densities according to formation temperature or pressure, and elements included in the bodies 100a and 100b may be partially different from each other, but the present disclosure is not limited thereto.

The magnetic material included in the body 100 may be ferrite powder particles or metal magnetic powder particles.

The ferrite power particles may include, for example, at least one selected from the group consisting of spinel-type ferrite power particles such as Mg—Zn-based ferrite powder particles, Mn—Zn-based ferrite powder particles, Mn—Mg-based ferrite powder particles, Cu—Zn-based ferrite powder particles, Mg—Mn—Sr-based ferrite powder particles, Ni—Zn-based ferrite powder particles, or the like, hexagonal ferrite power particles such as Ba—Zn-based ferrite powder particles, Ba—Mg-based ferrite powder particles, Ba—Ni-based ferrite powder particles, Ba—Co-based ferrite powder particles, Ba—Ni—Co-based ferrite powder particles, or the like, garnet-type ferrite power particles such as Y-based ferrite power particles or the like, and Li-based ferrite power particles.

The magnetic metal power particles may include one or more selected from the group consisting of iron (Fe), silicon (Si), chromium (Cr), cobalt (Co), molybdenum (Mo), aluminum (Al), niobium (Nb), copper (Cu), and nickel (Ni). For example, the magnetic metal power particles may include at least one selected from the group consisting of pure iron powder particles, Fe—Si-based alloy power particles, Fe—Si—Al-based alloy power particles, Fe—Ni-based alloy power particles, Fe—Ni—Mo-based alloy power particles, Fe—Ni—Mo—Cu-based alloy power particles, Fe—Co-based alloy power particles, Fe—Ni—Co-based alloy power particles, Fe—Cr-based alloy power particles, Fe—Cr—Si-based alloy power particles, Fe—Si—Cu—Nb-based alloy power particles, Fe—Ni—Cr-based alloy power particles, and Fe—Cr—Al-based alloy power particles.

The magnetic metal powder particles may be amorphous or crystalline. For example, the magnetic metal powder particles may include Fe—Si—B—Cr-based amorphous alloy powder particles, but the present disclosure is not limited thereto.

Each of the ferrite powder particles and the magnetic metal powder particles may have an average diameter of about 0.1 μm to about 30 μm, but the present disclosure is not limited thereto.

The body 100 may include two or more types of magnetic materials dispersed in the resin. Here, different types of magnetic materials mean that the magnetic materials dispersed in the resin are distinguished from each other by an average diameter, a composition, crystallinity, and/or a shape of the magnetic materials.

The resin may include an epoxy resin, a polyimide resin, a liquid crystal polymer, or the like alone or in combination, but the present disclosure is not limited thereto.

The body 100 may include a core 110. Referring to FIGS. 2 and 7, the core 110 may refer to a region of the body 100 charged to pass through an air core of the coil 200. Specially, the core 110 may be disposed in an internal region of a winding portion 210 forming at least one turn, and a cross-section of the core 110, perpendicular to a winding axis of the winding portion 210, may have a circular shape or an oval shape, but the present disclosure is not limited thereto.

Referring to FIGS. 1, 2, and 7, the body may include recesses R1 and R2. The recess R1 may be formed in a region in which the first surface 101 and the third surface 103 of the body 100 are connected to each other, a part of the first surface 101 and a part of the third surface 103 of the body, and the recess R2 may be formed in a region in which the second surface 102 and the third surface 103 of the body 100 are connected to each other, a part of the second surface 102 and a part of the third surface of the body.

The recesses R1 and R2 according to the present example embodiments may correspond to a region in which a step portion is formed toward the inside of the body 100 to accommodate the lead-out portions 221 and 222 and the external electrodes 300 and 400. For ease of description, a region in which the recesses R1 and R2 are formed may also be defined as being included in the first surface 101, the second surface 102, and the third surface 103.

In some embodiments, the external electrodes 300 and 400 may include base portions 310 and 410, pad portions 330 and 430, and insertion portions 320 and 420, respectively. The base portions 310 and 410 of the external electrodes 300 and 400 may be disposed in the recesses R1 and R2 formed in the first surface 101 and the second surface 102, and the pad portions 330 and 430 of the external electrodes 300 and 400 may be disposed in the recesses R1 and R2 formed in the third surface 103. That is, the external electrodes 300 and 400 may be bent and disposed on the body 100 along shapes of the recesses R1 and R2. In addition, insertion portions 320 and 420 of the external electrodes 300 and 400 may be inserted into the body 100 through the recesses R1 and R2. In addition, in the present example embodiments, the protrusion portions 350 and 450 formed on the external electrodes 300 and 400 may be in contact with the surface of the body at which the recesses are formed. In some embodiments, at least one protrusion portion 350 may be in contact with the first surface of body at which the recess is formed, and at least one protrusion portion 350 may be in contact with the third surface of the body at which the recess is formed. In some embodiments, at least one protrusion portion 450 may be in contact with the second surface of body at which the recess is formed, and at least one protrusion portion 450 may be in contact with the third surface of the body at which the recess is formed.

In some embodiments, the body 100 may not have the recesses 300 and 400, and thus the lead-out portions 221 and 222 and the external electrodes 300 and 400 may may be disposed on the body to protrude from a flat surface of the body 100, but the present disclosure is not limited thereto.

The coil 200 may be embedded in the body 100 to exhibit the characteristics of the coil component 1000. For example, when the coil component 1000 according to the present example embodiments is used as a power inductor, the coil 200 may store an electric field as a magnetic field to maintain an output voltage, thereby stabilizing power of an electronic device.

Referring to FIGS. 1 and 2, the coil 200 may include a winding portion 210 embedded in the body 100, and lead-out portions 221 and 222 extending from an end of the winding portion 210 onto the body 100.

The winding portion 210 may form at least one turn around the core 110. The lead-out portions 221 and 222 extend from both ends of the winding portion 210 toward outer surface of the body 100, and may be connected to the external electrodes 300 and 400. Specifically, the coil 200 may include a winding portion 210 forming at least one turn in the body 100, a first lead-out portion 221 lead out to the first surface 101, and a second lead-out portion 222 lead out to the second surface 102 of the body 100.

The first lead-out portion 221 may be disposed between the first surface of the body 100 and the first external electrode 300, and the second lead-out portion 222 may be disposed between the second surface of the body 100 and the second external electrode 400. The first lead-out portion 221 may extend along surfaces of the recesses R1 and R2 formed in the first and third surfaces 101 and 103 of the body 100, and the second lead-out portion 222 may extend along the surfaces of the recesses R1 and R2 formed in the second and third surfaces 102 and 103 of the body 100.

Referring to FIGS. 2 and 5, in the present example embodiments, the lead-out portions 221 and 222 may be disposed in the area between a plurality of protrusion portions 350a and 350b and a plurality of protrusion portions 450a and 450b formed on the internal surfaces of the external electrodes 300 and 400, respectively. Specifically, the first lead-out portion 221 may be disposed to pass through a space between the pair of adjacent protrusion portions 350a and 350b disposed in parallel in a third direction (W-direction), among the plurality of protrusion portions 350 formed on the internal surface of the first external electrode 300. In addition, the second lead-out portion 222 may be disposed to pass through a space between the pair of adjacent protrusion portions 450a and 450b disposed in parallel in the third direction (W-direction), among the plurality of protrusion portions 450 formed on the internal surface of the second external electrode 400. The lead-out portions 221 and 222 may be disposed to extend in a second direction (T-direction) or a first direction (L-direction) between the pair of protrusion portions 350a and 350b, and the pair of protrusion portions 450a and 450b disposed in parallel in the third direction (W-direction), such that positions of the lead-out portions 221 and 222 in contact with the internal surfaces of the external electrodes 300 and 400 may be guided.

Referring to FIG. 2, the lead-out portions 221 and 222 according to the present example embodiments may be lead out in a region closer to the fourth surface 104 than to the third surface 103 of the body 100, and disposed on the first surface 101 or the second surface 102 of the body 100, respectively. That is, assuming a centerline CL parallel to the first direction (L-direction) and passing through the center of the body 100, the lead-out portions 221 and 222 according to the present example embodiments may be lead out in a position higher than the centerline CL in a position closer to the fourth surface 104 than to the third surface 103 of the body 100.

As in the present example embodiments, when the lead-out portions 221 and 222 may be lead out in a position higher than the centerline CL, the base portions 310 and 410 of the external electrodes 300 and 400 may have a greater height, and the base portions 310 and 410 may also have an increased surface area. In the case of the coil component 1000 having the above-described structure, a fillet, reinforced by the protrusion portions 350 and 450 when the coil component 1000 is mounted on the board, may have a greater height, thereby increasing a stress relieving effect. In addition, a contact area between the lead-out portions 221 and 222 and the external electrodes 300 and 400 may be increased, and thus a DC resistance element R dc may also be reduced.

Referring to FIG. 2, at least a portion of each of the first lead-out portion 221 and the second lead-out portion 222 may be disposed to extend to the third surface 103 of the body 100 from the first surface 101 and the second surface 102 of the body, respectively, but the present disclosure is not limited thereto. When a thickness of the coil component 1000 needs to be reduced, the first lead-out portion 221 and the second lead-out portion 222 may be spaced apart from the third surface 103 of the body 100, and may be disposed only on the first surface 101 or the second surface 102.

Referring to FIGS. 3 to 5, the lead-out portions 221 and 222 may be formed by rolling both ends of the coil 200, and may be flat due to rolling. That is, a thickness T_{L} of each of the lead-out portions 221 and 222 may be less than a diameter of the coil 200, and a width W_{L} of each of the lead-out portions 221 and 222 may be greater than the diameter of the coil 200. For example, the diameter of the coil 200 may be 0.23 mm to 1.1 mm. In this case, the thickness T_{L} of each of the lead-out portions 221 and 222 may be 0.15 mm, and the width W_{L} of each of the lead-out portions 221 and 222 may be 0.28 mm to 4.4 mm, but the present disclosure is not limited thereto.

When the lead-out portions 221 and 222 and the external electrodes 300 and 400 may have a surface-contact structure therebetween as described above, such that a contact area between the lead-out portions 221 and 222 and the external electrodes 300 and 400 may be increased, thereby improving bonding reliability and improving R_{dc} characteristics.

The coil 200 according to the present example embodiments may correspond to an air-core coil and may be a wound-type coil, but the present disclosure is not limited thereto. A region of the coil 200, excluding the lead-out portions 221 and 222, which are connected to the external electrodes 300 and 400, may be coated with an insulating material. Accordingly, a surface of each turn of the winding portion 210 may be coated with an insulating material, such that insulating properties may be maintained even after winding.

Specifically, the winding portion 210 may be formed by winding a metal wire having a surface coated with an insulating material in a spiral shape. The metal wire may be a copper wire, but the present disclosure is not limited thereto.

The coil component 1000 according to the present example embodiments illustrates a case in which the winding portion 210 is formed using a circular wire, but the present disclosure is not limited thereto. When the winding portion 210 is formed using a metal wire that is a flat line, each turn of the winding portion 210 may have a quadrilateral cross-section.

The coil 200 according to the present example embodiments may include a conductive material at least one selected from the group consisting of such as copper (Cu), aluminum (Al), silver (Ag), tin (Sn), gold (Au), nickel (Ni), lead (Pb), titanium (Ti), chromium (Cr), molybdenum (Mo), and alloys thereof, but the present disclosure is not limited thereto.

Referring to FIGS. 1 and 2, the coil component 1000 according to the present example embodiments may include external electrodes 300 and 400 embedded in the body 100, the external electrodes 300 and 400 connected to the coil 200. In addition, in the present example embodiments, the external electrodes 300 and 400 may include an internal surface facing the body 100, and an external surface opposing the internal surface. The protrusion portions 350 and 450, protruding toward the body 100, may be formed on the internal surfaces of the external electrodes 300 and 400, and the external surfaces of the external electrodes 300 and 400 may have a flat shape. This may be because the external electrodes 300 and 400 may include a first metal layer ML1 and a second metal layer ML2 disposed on the first metal layer, wherein the protrusion portions 350 and 450 may be formed by the first metal layer ML1 having a portion protruding internal surface and a recessed external surface, and the second metal layer ML2 filling the recessed region formed by the external surface of the first meatal layer ML1. Accordingly, in the coil component 1000 of the present example embodiments, the protrusion portions 350 and 450 may not be visible on the external surfaces of the external electrodes 300 and 400. As a result, despite the formation of the protrusion portions 350 and 450, no significant difference in the exterior of the coil component 1000 may occur.

The external electrodes 300 and 400 may electrically connect the coil component 1000 and a circuit board to each other when the coil component 1000 according to the present example embodiments is mounted on the circuit board or the like. For example, the first and second external electrodes 300 and 400, disposed on the third surface 103 of the body 100 to be spaced apart from each other, may be electrically connected to a connection portion of the circuit board.

Specifically, the first external electrode 300 may be disposed on the first surface 101 of the body 100 to be in contact with the first lead-out portion 221 lead out to the first surface 101 of the body 100, and the second external electrode 400 may be disposed on the second surface 102 of the body 100 to be in contact with the second lead-out portion 222 extending to the second surface 102 of the body 100.

Referring to FIGS. 1 and 2, the external electrodes 300 and 400 according to the present example embodiment may include base portions 310 and 410, insertion portions 320 and 420, pad portions 330 and 430, and protrusion portions 350 and 450. Specifically, the first and second external electrodes 300 and 400 may include base portions 310 and 410 disposed on the first surface 101 or the second surface 102 of the body 100, insertion portions 320 and 420 bent from the base portions 310 and 410, the insertion portions 320 and 420 having at least a portion disposed in the body 100, and pad portions 330 and 430 bent from the base portions 310 and 410, the pad portions 330 and 430 extending to the third surface 103 of the body 100. In addition, the protrusion portions 350 and 450 may be disposed on at least one of the base portions 310 and 410 and the pad portions 330 and 430.

Here, the base portions 310 and 410, the insertion portions 320 and 420, the pad portions 330 and 430, and the protrusion portions 350 and 450 may be integrally formed. For ease of description, the external electrodes 300 and 400 may be divided into regions, and the regions may be defined as the base portions 310 and 410, the insertion portions 320 and 420, the pad portions 330 and 430, and the protrusion portions 350 and 450.

Referring to FIGS. 1 and 2, the base portion 310 of the first external electrode 300 may be disposed on the first surface 101 of the body 100, more specifically, in the recesses R1 and R2 formed on the first surface 101. In addition, the base portion 410 of the second external electrode 400 may be disposed on the second surface 102 of the body 100, more specifically, in the recesses R1 and R2 formed on the second surface 102.

The base portions 310 and 410 may be disposed to be in contact with the lead-out portions 221 and 222 lead out onto the body 100, and at least one protrusion portion 350 and at least one protrusion portion 450 may be disposed on the base portions 310 and 410. Specifically, the protrusion portions 350 and 450 protruding toward the body 100 may be disposed on internal surfaces of the base portions 310 and 410, and external surfaces of the base portions 310 and 410 may have a flat shape.

The lead-out portions 221 and 222 may be disposed between the base portions 310 and 410 and the body 100. Specifically, the first lead-out portion 221 may be disposed between the first base portion 310 and the first surface 101 of the body 100, and the second lead-out portion 222 may be disposed between the second base portion 410 and the second surface 102 of the body 100.

Referring to FIGS. 2 and 3, the thickness T_{L} of each of the lead-out portions 221 and 222 may be less than or equal to a thickness T_{P} of a region in which the protrusion portions 350 and 450 formed on the internal surfaces of the base portions 310 and 410 protrude in the second direction (L-direction). Through such a structure, when the lead-out portions 221 and 222 are disposed between the pair of protrusion portions 350a and 350b and the pair of protrusion portions 450a and 450b formed on the internal surfaces of the base portions 310 and 410, the lead-out portions 221 and 222 may be stably disposed in a space formed by the body 100 and the protrusion portions 350 and 450. In addition, the lead-out portions 221 and 222 may be finely spaced apart from the body 100, and the pair of adjacent protrusion portions 350a and 350b and the pair of adjacent protrusion portions 450a and 450b, formed on the internal surfaces of the base portions 310 and 410, may be disposed to be in contact with the body 100, thereby preventing the movement or twisting of the external electrodes 300 and 400.

Referring to FIGS. 1 and 2, the external electrodes 300 and 400 according to the present example embodiment may include insertion portions 320 and 420 bent from the base portions 310 and 410, the inserting portions 320 and 420 having at least a portion disposed on the body 100. At least portions of the insertion portions 320 and 420 may be inserted into the body 100, and may be in contact with the lead-out portions 221 and 222. The insertion portions 320 and 420 may serve to fix the external electrodes 300 and 400 to the body 100, and may include anchor portions 321 and 421 at inner ends thereof.

The anchor portions 321 and 421 may perform an anchoring function in the body 100 to further enhance bonding force of the external electrodes 300 and 400 with the body 100. The anchor portions 321 and 421 may have a shape protruding from the inner ends of the insertion portions 320 and 420 in the third direction W, but the present disclosure is not limited thereto. A protrusion direction or protrusion shape of the anchor portions 321 and 421 may be formed in various manners. In addition, the anchor portions 321 and 421 may be formed at both sides of the inner ends of the insertion portions 320 and 420, or may be formed only on one side of the inner ends of the insertion portions 320 and 420.

Referring to FIGS. 1 and 2, the pad portions 330 and 430 may be bent from the base portions 310 and 410 and extend to the third surface 103 of the body 100. The pad portions 330 and 430 may extend in the first direction (L-direction) and may be disposed in the recesses R1 and R2, respectively, formed in the third surface 103 of the body 100. Specifically, the first pad portion 330 may be bent from the first base portion 320 in the first direction (L-direction) and disposed in the first recess R1 formed in the third surface 103 of the body 100, and the second pad portion 430 may be bent from the second base portion 420 in the first direction (L-direction) and disposed in the second recess R2 formed in the third surface 103 of the body 100.

The pad portions 330 and 430 may be connected to the connection portion of the circuit board when the coil component 1000 according to the present example embodiment is mounted on the board. For example, a bonding member, such as a solder, may be disposed between the pad portions 330 and 430 and the connection portion of the board, such that the coil component 1000 and the board may be electrically connected to each other.

When the coil component 1000 is mounted on the board, as compared to a case in which the pad portions 330 and 430 and the connection portion of the board are connected to each other by solder, bonding force between the coil component 1000 and the board may be enhanced when the solder extends up to a portion of the base portions 310 and 410 to form a fillet. In this case, in the coil component 1000 according to some example embodiment of the present disclosure, in addition to the fillet formed by solder, the second metal layer ML2 may flow downwardly from the protrusion portions 350 and 450 formed on the base portions 310 and 420 during a reflow process, thereby further reinforcing the fillet.

Referring to FIGS. 1 to 5, the coil component 1000 according to the first example embodiment of the present disclosure may include at least one protrusion portion 350 and at least one protrusion 450 respectively protruding from internal surfaces of the external electrodes 300 and 400 toward the body 100. The protrusion portions 350 and 450 according to the present example embodiment may include a semicircular cross-section. Here, the semicircular cross-section may not exactly refer to a semicircular shape, but also refer to a cross-section having an arc shape or a portion of an oval.

Referring to FIGS. 3 to 5, the external electrodes 300 and 400 may include a first metal layer ML1 disposed on the body 100 and a second metal layer ML2 disposed on the first metal layer ML1, and the protrusion portions 350 and 450 included in the external electrodes 300 and 400 may include a first metal layer ML1 protruding toward the body 100, and a second metal layer ML2 filling a recessed region formed in an external surface of the first metal layer ML1. Here, the second metal layer ML2 may include Sn.

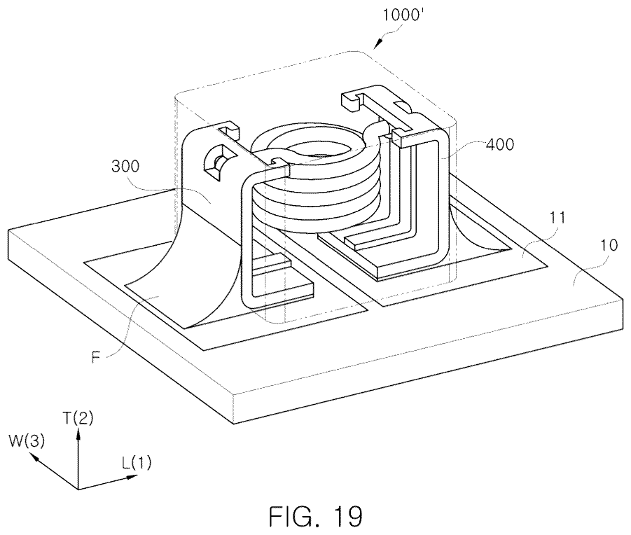

The second metal layer ML2, filling the recessed region formed in the external surface of the first metal layer ML1, may reinforce a fillet F formed through a reflow process when the coil component 1000 is mounted on the board, thereby enhancing bonding force between the board and the coil component 1000. The form and effect of reinforcing the fillet F will be described below with reference to FIGS. 19 to 23.

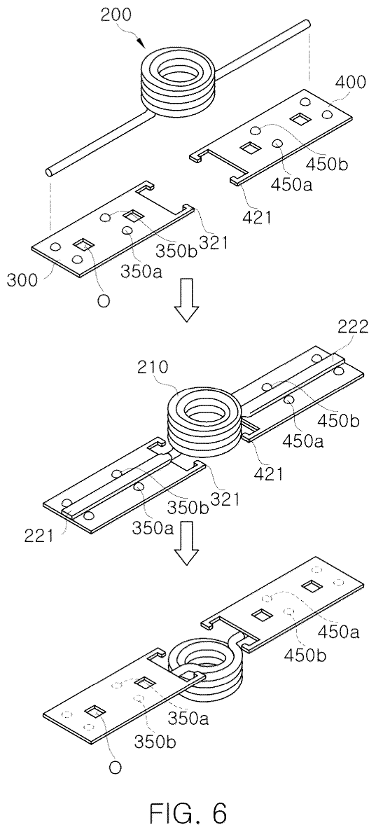

Referring to FIGS. 2 to 5, the external electrodes 300 and 400 of the coil component 1000 according to a first example embodiment of the present disclosure may include base portions 310 and 410, and protrusion portions 350 and 450 respectively disposed on the pad portions 330 and 430. A plurality of protrusion portions 350 and 450 may be disposed on the base portions 310 and 410. In addition, the plurality of protrusion portions 350 and 450 may be disposed on the pad portions 330 and 430. In some embodiments, the external electrodes 300 and 400 may include the plurality of the protrusion portions 350 and 450 both on the base portions 310 and 410 and the pad portions 330 and 430, respectively. Preferably, an even number of the protrusion portions 350 and 450 may be formed. Referring to FIG. 6, for example, in the first external electrode 300, the first lead-out portion 221 may be disposed between a pair of adjacent protrusion portions 350a and 350b disposed in parallel in the third direction (W-direction). Similarly, in the second external electrode 400, the second lead-out portion 222 may be disposed between a pair of adjacent protrusion portions 450a and 450b disposed in parallel in the third direction (W-direction). That is, the pair of adjacent protrusion portions 350a and 350b and the pair of adjacent protrusion portions 450a and 450b may be disposed in parallel in a direction, perpendicular to a direction in which the lead-out portions 221 and 222 extend on the body 100.

Referring to FIGS. 3 and 4, a thickness (T_{L}) of each of the lead-out portions 221 and 222 may be less than or equal to a thickness (T_{P}) of each of protruding regions of the protrusion portions 350 and 450. When the thickness (T_{L}) of each of the lead-out portions 221 and 222 is greater than the thickness (T_{P}) of each of the protrusion portions 350 and 450, the protrusion portions 350 and 450 may be spaced apart from the body 100, and accordingly, the movement or twisting of the external electrodes 300 and 400 may occur. In the present example embodiments, the thickness (T_{P}) of each of the protruding regions of the protrusion portions 350 and 450 may be formed to be greater than or equal to the thickness (T_{L}) of each of the lead-out portions 221 and 222, such that the external electrodes 300 and 400 may be stably fixed to the body 100.

Here, with respect to an optical microscope image or an SEM image of an L-T cross-section obtained by cutting a central portion of the coil component 1000 in the third direction W, the thickness (T_{L}) of each of the lead-out portions 221 and 222 may refer to an arithmetic mean value of at least three dimensions among dimensions of a plurality of line segments connecting, to each other, two outermost boundary lines of each of the lead-out portions 221 and 222 opposing each other in the first direction (L-direction) illustrated in the image, to be parallel to the first direction (L-direction), the plurality of line segments spaced apart from each other in the second direction (T-direction). Here, the plurality of line segments, parallel to the first direction (L-direction), may be equally spaced from each other in the second direction (T-direction), but the present disclosure is not limited thereto.

In addition, the thickness (T_{P}) of each of the protrusion portions 350 and 450 may be defined as a distance from an internal surface of each of the external electrodes 300 and 400, that is, a flat surface of the first metal layer ML1 in contact with the lead-out portion 221 to a point at which each of the protrusion portions 350 and 450 protrude most toward the body 100. Here, the thickness (T_{P}) of each of the protrusion portions 350 and 450 may refer to a dimension of a line segment connecting, to each other, an extension line of the flat surface of the first metal layer ML1 in contact with the lead-out portion 221, illustrated in the image, and the point at which each of the protrusion portions 350 and 450 protrude most toward the body 100 to be parallel to the first direction (L-direction).

The measurement method is described based on the protrusion portions 350 and 450 formed on the base portions 310 and 410 as illustrated in FIG. 3, but may be similarly applied to the protrusion portions 350 and 450 formed on the pad portions 330 and 430 as illustrated in FIG. 4.

Referring to FIGS. 1 and 5, for example, the pair of adjacent protrusion portions 350a and 350b may be formed on the internal surface of the first external electrode 300, and may be disposed in parallel in the third direction (W-direction), and a minimum distance (W_{G}) between the protrusion portions 350a and 350b may be greater than a maximum line width (W_{L}) of the lead-out portion 221.

Here, with respect to an optical microscope image or an SEM image of an L-W cross-section, passing through the center of each of the protrusion portions 350a and 350b, the L-W cross-section perpendicular to the second direction (T-direction), the maximum line width (W_{L}) of the lead-out portion 221 may refer to a maximum value among dimensions of a plurality of line segments connecting, to each other, two outermost boundary lines of each of the lead-out portions 221 and 222 opposing each other in the third direction (W-direction) illustrated in the image, to be parallel to the third direction (W-direction), the plurality of line segments spaced apart from each other in the first direction (L-direction). The plurality of line segments, parallel to the third direction (W-direction), may be equally spaced apart from each other in the first direction (L-direction), but the present disclosure is not limited thereto.

In addition, the minimum distance (W_{G}) between the protrusion portions 350a and 350b may refer to a minimum value among dimensions of a plurality of line segments, each of which extends parallel to a third direction (W-direction) between two extension lines that are parallel to a first direction (L-direction) and pass through the starting points of the adjacent protrusion portions 350a and 350b illustrated in the image.

Heights of the pair of adjacent protrusion portions 350a and 350b may be substantially the same. Here, “being substantially the same” may refer to being identical while accounting for factors such as process errors, positional deviations, or measurement inaccuracies that may arise during manufacturing. In addition, the height of each of the protrusion portions 350a and 350b may be defined to be the same as the above-described thickness (T_{P}) of each of the protruding regions, and may be measured using a method similar to the measurement method described above with respect to the thickness (T_{P}) of each of the protruding regions of the protrusion portions 350a and 350b.

The pair of adjacent protrusion portions 350a and 350b may have substantially the same height T_{P}, thereby preventing the movement or twisting of the external electrodes 300 and 400, and stably fixing the external electrodes 300 and 400 to the body 100.

In addition, although not illustrated, the protrusion portions 450a and 450b of the second external electrode 400 may also have features the same as those of the protrusion portions 350a and 350b of the first external electrode 300 described above.

Referring to FIG. 5, a width (W_{P}) of each of the protrusion portions 350 and 450 according to the present example embodiment may be twice or more than an average thickness of each of the external electrodes 300 and 400. For example, the width (W_{P}) of each of the protrusion portions 350 and 450 may be 0.15 mm to 0.65 mm. In addition, a width (W_{E}) of each of the external electrodes 300 and 400 in the third direction (W-direction) may be 2 mm to 5 mm. However, the above-described values are exemplary values, and the present disclosure is not limited thereto.

Referring to FIG. 1, the external electrodes 300 and 400 according to the present example embodiment may further include an opening O formed in at least a portion of a bent region between the base portions 310 and 410 and the insertion portions 320 and 420 and a bent region between the base portions 310 and 410 and the pad portions 330 and 430.

The opening O may pass through the external electrodes 300 and 400, and a load may be reduced during a process of bending the external electrodes 300 and 400 from a flat shape, thereby preventing damage to the external electrodes 300 and 400. When the external electrodes 300 and 400 have sufficient rigidity to withstand a load generated during a bending process, the opening O may be omitted.

The external electrodes 300 and 400 according to the present example embodiment may include a conductive material selected from the group consisting of such as copper (Cu), aluminum (Al), silver (Ag), tin (Sn), gold (Au), nickel (Ni), lead (Pb), titanium (Ti), chromium (Cr), molybdenum (Mo), and alloys thereof, and may be formed in multiple layers, but the present disclosure is not limited thereto. In addition, the external electrodes 300 and 400 may be fixed to the frame through a rolling process, but the present disclosure is not limited thereto.

Although not illustrated, the coil component 1000 according to the present example embodiment may further include an insulating layer covering a surface of the body 100.

The insulating layer may be formed by methods such as printing, vapor deposition, spray coating, or film lamination, but the present disclosure is not limited thereto.

The insulating layer may include a thermoplastic resin such as a polystyrene-based resin, a vinyl acetate-based resin, a polyester-based resin, a polyethylene-based resin, a polypropylene-based resin, a polyamide-based resin, a rubber-based resin, an acryl-based resin, or the like, a thermosetting resin such as a phenol-based resin, an epoxy-based resin, a urethane-based resin, a melamine-based resin, an alkyd-based resin, or the like, a photosensitive resin, parylene, SiOₓ or SiNₓ. The insulating layer may further include an insulating filler such as an inorganic filler, but the present disclosure is not limited thereto.

FIG. 6 is a schematic diagram illustrating a process of forming the coil 200 and the external electrodes 300 and 400 of the coil component 1000 according to a second example embodiment of the present disclosure. FIG. 7 is an exploded perspective view of FIG. 1, and illustrates a form of the external electrode before bending.

Referring to FIG. 6, in the coil component 1000 according to the present example embodiment, the external electrodes 300 and 400 may be first formed on a frame, and the coil 200 may be disposed on the external electrodes 300 and 400. The lead-out portions 221 and 222 may be disposed between the pair of adjacent protrusion portions 350a and 350b and the pair of adjacent protrusion portions 450a and 450b, respectively.

The anchor portions 321 and 421, the opening O, and the protrusion portions 350 and 450 may be formed in advance on the external electrodes 300 and 400 using the frame before coupling with the coil 200, the lead-out portions 221 and 222 at both ends of the coil 200 may be coupled to the external electrodes 300 and 400 after the insulation layer is removed and rolled, and an additional cover layer may be formed through dipping, soldering, or the like in a coupling process, but the present disclosure is not limited thereto. The coil 200 and the external electrodes 300 and 400 may be re-disposed in a direction of being embedded in the body 100.

Referring to FIG. 7, based on a configuration in which the coil 200 formed in FIG. 6 and the external electrodes 300 and 400 are coupled to each other, a body 100 may be formed by pressing and curing upper and lower regions 100a and 100b of the body 100 in a vertical direction, respectively. A portion of the lower region 100b of the body 100 may fill an air core of the coil 200 in the direction of FIG. 7 to form the core 110, but the present disclosure is not limited thereto.

As described, after the body 100 is formed, the external electrodes 300 and 400 may be mounted in the recesses R1 and R2 by bending the lead-out portions 221 and 222 and the external electrodes 300 and 400, respectively, twice along a shape of the body 100.

### Modification of First Example Embodiment

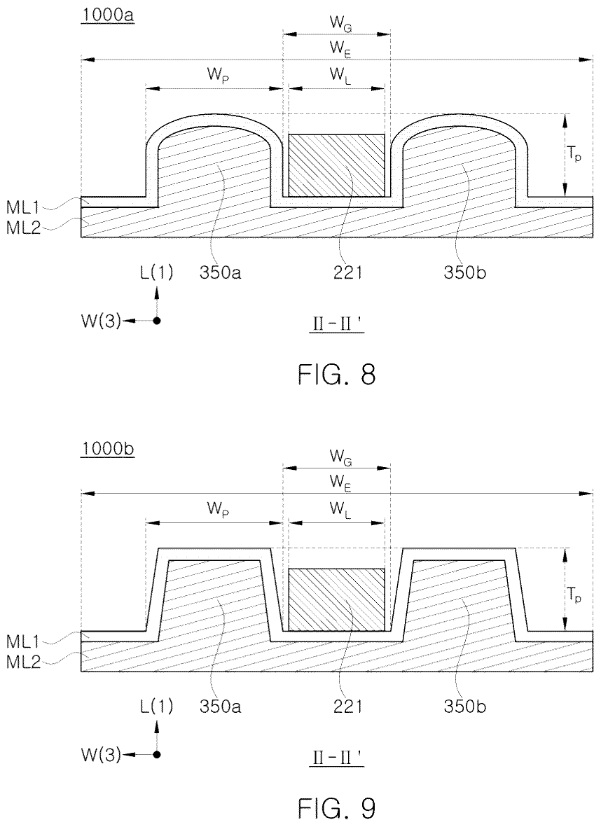

FIGS. 8 to 11 are diagrams illustrating modifications of a cross-sectional shape of the protrusion portions 350 and 450 of FIG. 5.

Comparing FIGS. 8 to 11 with FIG. 5, coil components 1000a, 1000b, 1000c, and 1000d according to the present modifications may have different L-W cross-sectional shapes of a pair of adjacent protrusion portions 350a and 350b. Accordingly, in describing the present modifications, only the cross-sectional shapes of the protrusion portions 350a and 350b, different from those in the first example embodiment of the present disclosure, will be described, and the description of the first example embodiment of the present disclosure may be applied to remaining components in the same manner.

Referring to FIG. 8, the protrusion portions 350a and 350b of the coil component 1000a according to a first modification may include an arch-shaped cross-section. That is, the protrusion portions 350a and 350b according to the present modification may have a cylindrical shape having a rounded upper surface. However, the shape is not limited to the cylindrical shape, and the protrusion portions 350a and 350b may also have a shape of an angled column having planar side surfaces. In the present modification, when the lead-out portion 221 is thick, a height (T_{P}) of each of the protrusion portions 350a and 350b may be increased without increasing an area of each of the protrusion portions 350a and 350b.

Referring to FIG. 9, the protrusion portions 350a and 350b of the coil component 1000b according to a second modification may include a tapered cross-section. That is, the protrusion portions 350a and 350b according to the present modification may have a cylindrical shape having a cross-sectional area that gradually increases from an upper surface to a lower surface thereof. However, the shape is not limited to the cylindrical shape, and the protrusion portions 350a and 350b may also have a shape of an angled column having planar side surfaces. In the present modification, the protrusion portions 350a and 350b may have inclined side surfaces. When the lead-out portion 221 is disposed, the lead-out portion 221 may be mounted in a correct position along a side surface inclination even when the alignment is slightly distorted.

Referring to FIG. 10, the protrusion portions 350a and 350b of the coil component 1000c according to a third modification may include a triangular cross-section. That is, the protrusion portions 350a and 350b according to the present modification may have a conical shape. However, the shape is not limited to the conical shape, and may also have a polygonal pyramid shape having planar side surfaces. In the present modification, the protrusion portions 350a and 350b may have inclined side surfaces. When the lead-out portion 221 is disposed, the lead-out portion 221 may be mounted in a correct position along a side surface inclination even when the alignment is slightly distorted. A wide-open space may be present between a pair of adjacent protrusion portions 350a and 350b, such that the lead-out portion 221 may be easily disposed.

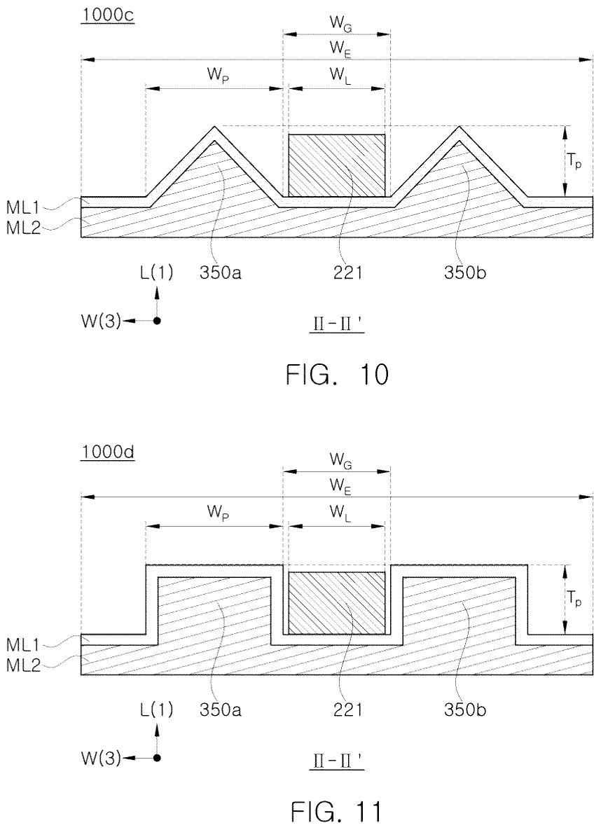

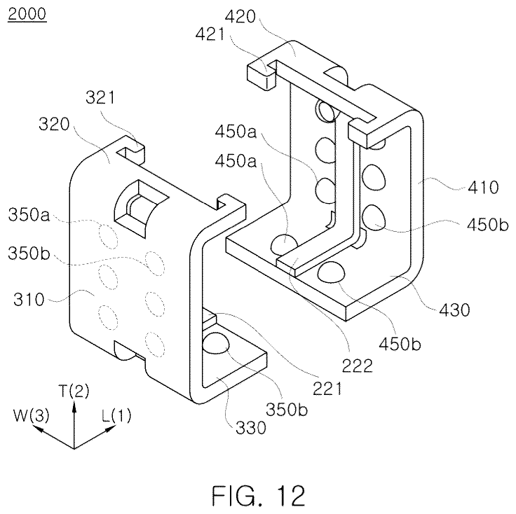

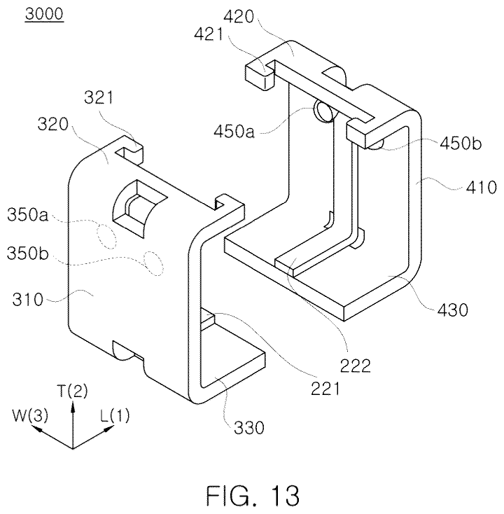

Referring to FIG. 11, the protrusion portions 350a and 350b of the coil component 1000d according to a fourth modification may include a quadrilateral cross-section. That is, the protrusion portions 350a and 350b according to the present modification may have a cylindrical shape. However, the shape is not limited to the cylindrical shape, and may also have a shape of a polygonal column having planar side surfaces. In the present modification, a contact area between the protrusion portions 350a and 350b and the body 100 may be increased, such that the effect of supporting the external electrodes 300 of the protrusion portions 350a and 350b may be improved, and an amount of the second metal layer ML2 filled in the protrusion portions 350a and 350b may be increased. Thus, the effect of reinforcing a fillet formed by soldering when the coil component 1000d is mounted on a board may also be improved.

### Second Example Embodiment, Third Example Embodiment, and Fourth Example Embodiment

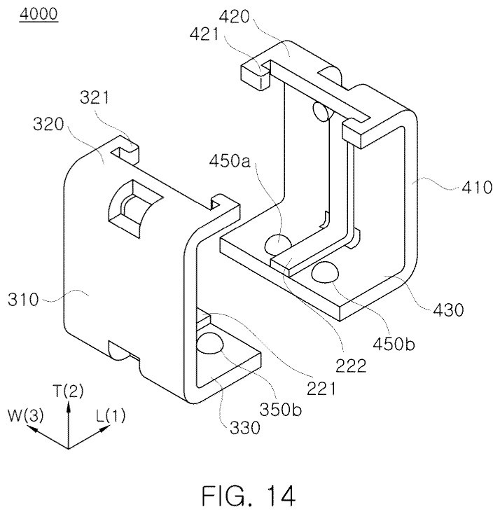

FIG. 12 is a diagram illustrating lead-out portions 221 and 222 and external electrodes 300 and 400 of a coil component 2000 according to a second example embodiment of the present disclosure. FIG. 13 is a diagram illustrating lead-out portions 221 and 222 and external electrodes 300 and 400 of a coil component 3000 according to a third example embodiment of the present disclosure. FIG. 14 is a diagram illustrating lead-out portions 221 and 222 and external electrodes 300 and 400 of a coil component 4000 according to a fourth example embodiment of the present disclosure. In FIGS. 12 to 14, a body 100 and a winding portion 210 are omitted to clearly illustrate detailed shapes of the lead-out portions 221 and 222 and the external electrodes 300 and 400.

Comparing FIGS. 12 to 14 with FIG. 1, a difference may present in terms of the number and arrangement of the protrusion portions 350 and 450. Accordingly, in the description of the present example embodiments, only the number and arrangement of the protrusion portions 350 and 450, different from those in a first example embodiment of the present disclosure, will be described, and the description of a first example embodiment of the present disclosure may be applied to remaining components in the same manner.

Referring to FIG. 12, in the coil component 2000 according to a second example embodiment of the present disclosure, the number of protrusion portions 350 and 450 disposed on each of base portions 310 and 410 may be three or more. For example, in the present example embodiment, three pairs, that is, six protrusion portions 350 and 450 may be disposed on each of the base portions 310 and 410, and lead-out portions 221 and 222 may be disposed to pass through a space between adjacent protrusion portions 350a and 350b and adjacent protrusion portions 450a and 450b in the third direction (W-direction).

In the present example embodiment, the guiding effect of the lead-out portions 221 and 222 may be further improved, and the support effect of the external electrodes 300 and 400 may be further enhanced. In addition, a fillet reinforcement effect may be further improved by a second metal layer ML2 (for example, Sn) filled in each of the six protrusion portions 350 and 450. In addition, the six protrusion portions 350 and 450 may be disposed in three layers in the second direction (T-direction), an appropriate amount of fillet reinforcement may be applied according to a height of a fillet formed when mounted on a board.

In the present example embodiment, the number of the protrusion portions 350 and 450, disposed on the base portions 310 and 410, is exemplary and is not limited thereto, and may be increased or decreased, as necessary. Preferably, the number of the protrusion portions 350 and 450 may be increased or decreased in even units.

Referring to FIG. 13, in the coil component 3000 according to a third example embodiment of the present disclosure, a pair of protrusion portions 350a and 350b and a pair of protrusion portions 450a and 450b may be respectively disposed on base portions 310 and 410, and the protrusion portions may be omitted from pad portions 330 and 430.

Heights of the pair of protrusion portions 350a and 350b and the pair of protrusion portions 450a and 450b, disposed on the base portions 310 and 410 of the present example embodiment, may be adjusted. In the present example embodiment, the pair of protrusion portions 350a and 350b and the pair of protrusion portions 450a and 450b may be formed in regions close to the insertion portions 320 and 420, but the present disclosure is not limited thereto. The pair of protrusion portions 350a and 350b and the pair of protrusion portions 450a and 450b may be formed in regions closer to the pad portions 330 and 430 in consideration of a height of a fillet formed by solder when mounted on a board.

Referring to FIG. 14, in the coil component 4000 according to a fourth example embodiment of the present disclosure, a pair of protrusion portions 350a and 350b and a pair of protrusion portions 450a and 450b may be respectively disposed on pad portions 330 and 430, and protrusion portions may be omitted from base portions 320 and 420.

The protrusion portions 350a and 350b and the protrusion portions 450a and 450b, disposed on the pad portions 330 and 430 according to the present example embodiment, may enhance bonding force between the pad portions 330 and 430 and a connection portion of a board by coupling a second metal layer ML2 (for example, Sn) filled in the protrusion portions 350a and 350b and the protrusion portions 450a and 450b with solder when the coil component 4000 is mounted on the board.

### Fifth Example Embodiment, Sixth Example Embodiment, and Seventh Example Embodiment

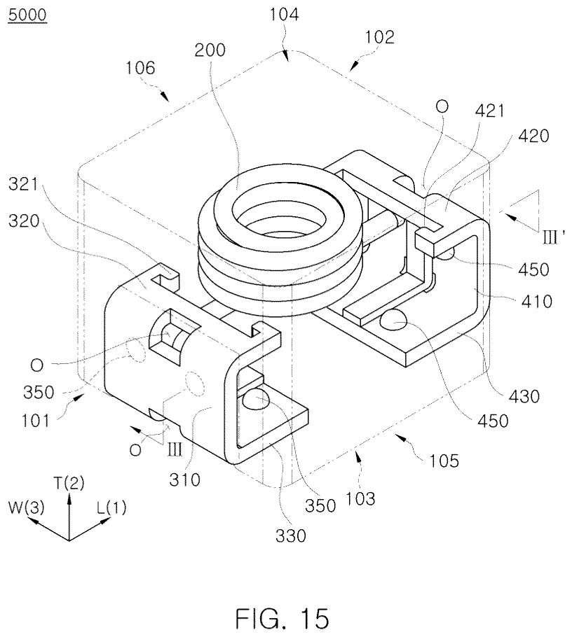

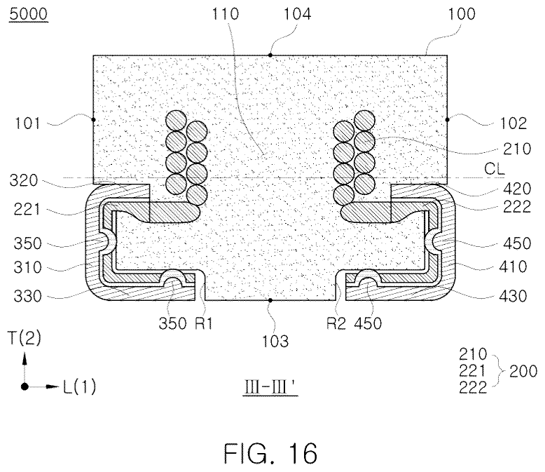

FIG. 15 is a schematic perspective view of a coil component 5000 according to a fifth example embodiment of the present disclosure. FIG. 16 is a cross-sectional view taken along line III-III′ of FIG. 15. In FIG. 15, a body 100 is illustrated in a transparent manner to clearly represent an arrangement relationship between elements.

Comparing FIGS. 15 and 16 with FIGS. 1 and 2, respectively, a difference may be present in terms of a position in which each of lead-out portions 221 and 222 is lead out onto a body 100, a position in which each of insertion portions 320 and 420 is inserted into the body 100, and a length of each of base portions 310 and 410 in the second direction (T-direction). Accordingly, in describing the present example embodiment, only the position in which each of the lead-out portions 221 and 222 is lead out onto the body 100, the position in which each of the insertion portions 320 and 420 is inserted into the body 100, and the length of each of the base portions 310 and 410 in the second direction (T-direction), different from those in a first example embodiment of the present disclosure, will be described, and the description of a first example embodiment of the present disclosure may be applied to remaining components in the same manner.

Referring to FIGS. 15 and 16, the lead-out portions 221 and 222 according to the present example embodiment may be lead out in a region closer to a third surface 103 than to a fourth surface 104 of the body 100, on a first surface 101 or a second surface of the body 100. Alternatively, the lead-out portions 221 and 222 may be lead out in a central region in the second direction (T-direction), on the first surface 101 or the second surface of the body 100. That is, when a centerline CL passing through the center of the body 100 and parallel to the first direction (L-direction) is assumed, the lead-out portions 221 and 222 according to the present example embodiment may be lead out onto the body 100 in a position the same as or lower than that of the centerline CL.

In addition, as a lead out height of each of the lead-out portions 221 and 222 of the coil component 5000 according to the present example embodiment is lowered, a height at which each of the insertion portions 320 and 420 of the external electrodes 300 and 400 is inserted into the body 100 may be lowered, and a length of each of the base portions 310 and 410 of the external electrodes 300 and 400 in the second direction (T-direction) may be reduced.

As in the present example embodiment, when the lead-out portions 221 and 222 are lead out at a height lower than or the same as that of the centerline CL, and thus the height of each of the insertion portions 320 and 420 is lowered and the length of each of the base portions 310 and 410 in the second direction (T-direction) is reduced, an overall center of gravity of the coil component 5000 may be lowered. Thus, vibration resistance may be improved when mounted on a board, thereby further improving a vibration resistance enhancement effect caused by the protrusion portions 350 and 450 included in the external electrodes 300 and 400.

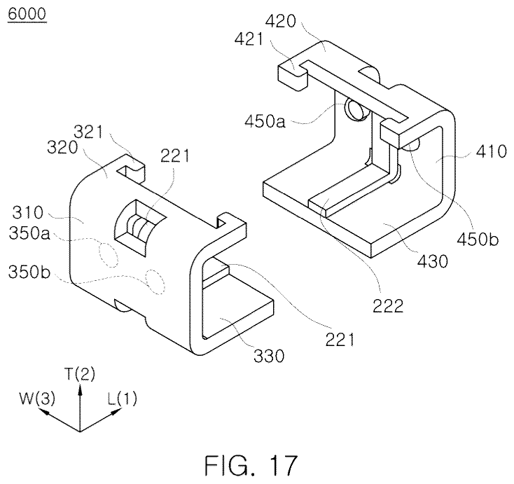

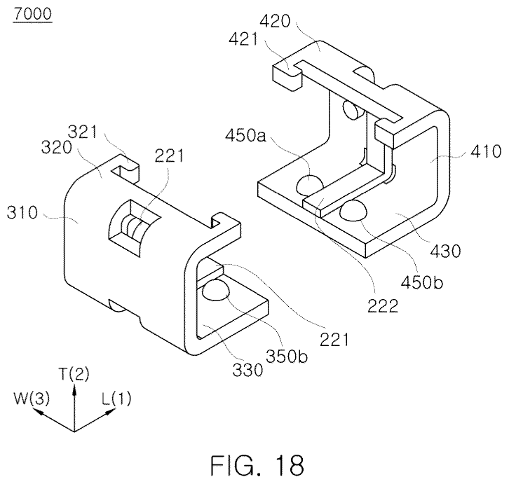

FIG. 17 is a diagram illustrating lead-out portions 221 and 222 and external electrodes 300 and 400 of a coil component 6000 according to a sixth example embodiment of the present disclosure. FIG. 18 is a diagram illustrating lead-out portions 221 and 222 and external electrodes 300 and 400 of a coil component 7000 according to a seventh example embodiment of the present disclosure. In FIGS. 17 and 18, a body 100 and a winding portion 210 are omitted so as to clearly represent detailed shapes of the lead-out portions 221 and 222 and the external electrodes 300 and 400.

Comparing FIGS. 17 and 18 with FIG. 15, a difference may be present in terms of the arrangement of protrusion portions 350 and 450. Accordingly, in describing the present example embodiments, only the arrangement of the protrusion portions 350 and 450, different from those in a fifth example embodiment of the present disclosure, will be described, and the description of a fifth example embodiment of the present disclosure may be applied to remaining components in the same manner.

Referring to FIG. 17, in the coil component 6000 according to the sixth example embodiment of the present disclosure, a pair of protrusion portions 350a and 350b and a pair of protrusion portions 450a and 450b may be respectively disposed on base portions 310 and 410, and the protrusion portions may be omitted from pad portions 330 and 430.

In the same manner as the coil component 5000 according to a fifth example embodiment, the coil component 6000 according to the present example embodiment may have a low center of gravity. Specifically, as lead-out portions 221 and 222 are lead out at a low level, positions of insertion portions 320 and 420 may also be lowered, and lengths of the base portions 310 and 410 may be reduced. Accordingly, an area of each of the base portions 310 and 410 may be reduced, such that a pair of protrusion portions 350a and 350b and a pair of protrusion portions 450a and 450b may be disposed on the base portions 310 and 410, respectively, but the present disclosure is not limited thereto. When the protrusion portions 350 and 450 are formed to have a small diameter or width, the number of the protrusion portions 350 and 450 may be increased.

Although not illustrated, the lead-out portions 221 and 222 may be disposed so as not to extend up to the pad portions 330 and 430, such that the body 100 and the pad portions 330 and 430 may come into close contact with each other, thereby reducing a size of the component, or the body 100 may be expanded to a space between the pad portions 330 and 430 and the body 100 secured by omitting the lead-out portions 221 and 222 and the protrusion portions 350 and 450, thereby increasing an effective volume.

Referring to FIG. 18, in the coil component 7000 according to a seventh example embodiment of the present disclosure, a pair of protrusion portions 350a and 350b and a pair of protrusion portions 450a and 450b may be respectively disposed on pad portions 330 and 430, and the protrusion portions may be omitted from base portions 320 and 420.

In the same manner as the coil component 5000 according to a fifth example embodiment, the coil component 7000 according to the present example embodiment may have a low center of gravity. Specifically, as lead-out portions 221 and 222 are lead out at a low level, positions of insertion portions 320 and 420 may also be lowered, and lengths of the base portions 310 and 410 may be reduced. In the present example embodiment, the protrusion portions 350 and 450 on the base portions 310 and 410 may be omitted, and thus a center of gravity of the coil component 7000 may be further lowered, thereby improving vibrational resistance when mounted on a board. In addition, as the protrusion portions 350 and 450 on the base portions 310 and 410 are omitted, lengths of the base portions 310 and 410 in the second direction (T-direction) may be reduced, thereby further lowering the center of gravity.

The protrusion portions 350a and 350b and the protrusion portions 450a and 450b, disposed on the pad portions 330 and 430 according to the present example embodiment, may enhance bonding force between the pad portions 330 and 430 and a connection portion of a board by coupling a second metal layer ML2 (for example, Sn) filled in the protrusion portions 350a and 350b and the protrusion portions 450a and 450b with solder when the coil component 7000 is mounted on the board.

Changes in Fillet Shape and Stress when Coil Component is Mounted on Board

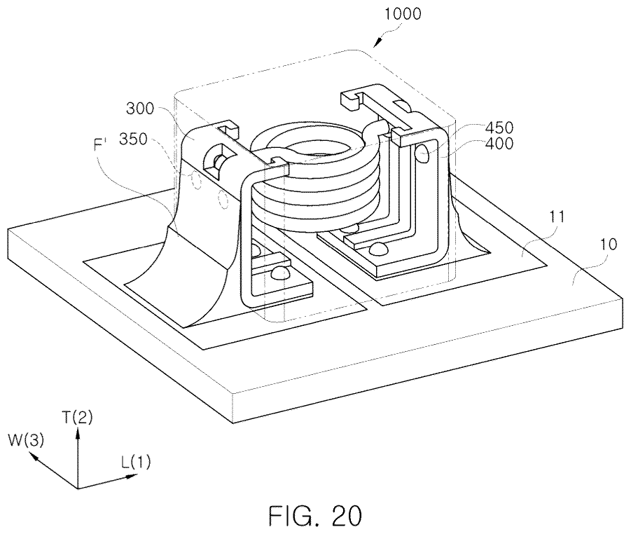

FIG. 19 is a schematic diagram illustrating a form in which a fillet F is formed when a coil component 1000′ in which protrusion portions 350 and 450 are omitted from FIG. 1 is mounted on a board 10. FIG. 20 is a schematic diagram illustrating a form in which a fillet F is reinforced when the coil component 1000 of FIG. 1 is mounted on a board 10.

Referring to FIG. 19, when the coil component 1000′ is mounted on a board 10, solder may be disposed the external electrodes 300 and 400 and a connection portion 11 through a reflow process, and thus the coil component 1000′ and the board 10 may be electrically connected to each other. In this case, the fillet F, disposed up to a portion of side surfaces of the external electrodes 300 and 400, may be formed to enhance bonding strength.

Comparing FIG. 20 with FIG. 19, when the coil component 1000 according to a first example embodiment of the present disclosure is mounted on the board 10, a reinforced fillet F′ may be formed as a Sn component, filled in the protrusions 350 and 450 included in the external electrodes 300 and 400, flows downwardly due to a reflow process. An amount of the fillet F′ to be reinforced or a curvature value of an inclined surface may be adjusted according to a diameter or formation position of each of the protrusions 350 and 450.

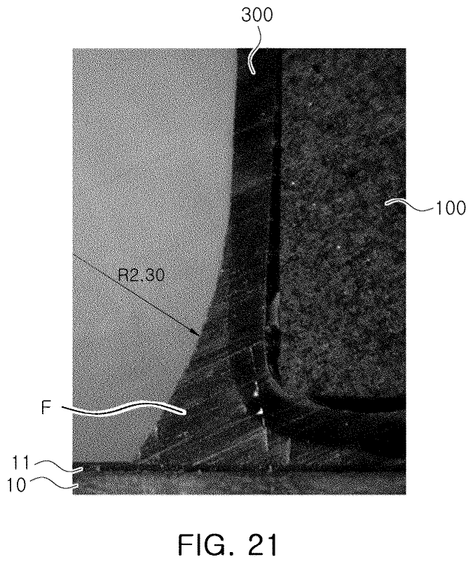

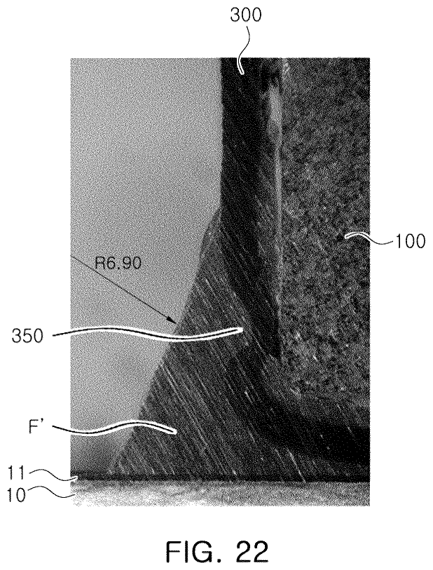

FIG. 21 is an experimental example illustrating a form in which a fillet F is formed when a coil component not including protrusion portions 350 and 450 is mounted on a board 10. FIG. 22 is an experimental example illustrating a form in which a fillet F is formed when a coil component including protrusion portions 350 and 450 is mounted on a board 10.

A sample was used, which had a solder thickness of 50 μm, an external electrode thickness of 0.2 mm for electrodes 300 and 400, a protrusion portion radius of 0.27 mm for protrusion portions 350 and 450, and protrusion portions positioned as in the fifth example embodiment of FIG. 15.

Referring to FIG. 21, when the coil component, not including protrusion portions 350 and 450 on the external electrodes 300 and 400, is mounted on the board 10, a cross-section of the fillet F formed by soldering had a curvature (R) of 2.30.

Comparing FIG. 22 with FIG. 21, when the coil component, including the protrusions 350 and 450 on the external electrodes 300 and 400, is mounted on the board 10, a cross-section of the fillet F′ reinforced by the protrusion portions 350 and 450 had a curvature (R) of 6.90.

When the protrusion portions 350 and 450 were disposed on the external electrodes 300 and 400 as described above, it was confirmed that the curvature of the formed fillet F′ increased threefold, and the amount of the formed fillet F′ also increased.

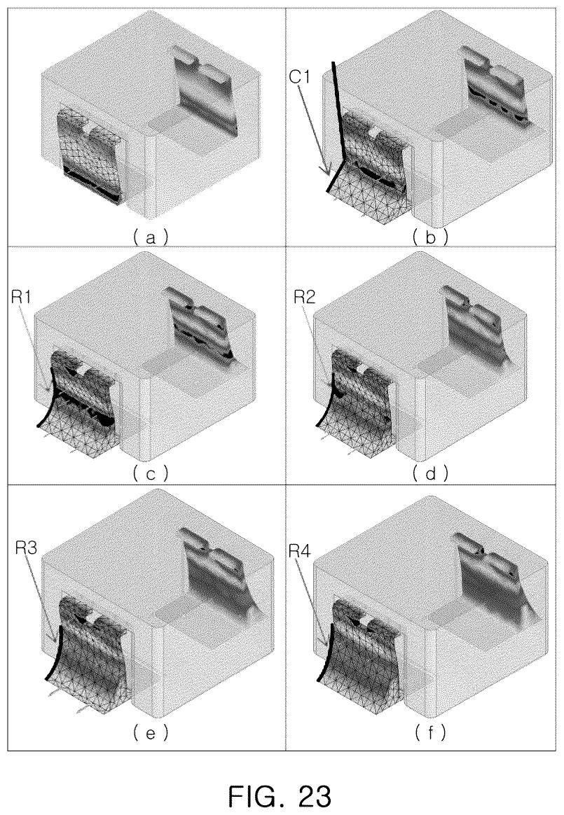

FIG. 23 is an example illustrating a simulation result of a stress change according to fillet formation and fillet reinforcement. A protrusion portion was set to be positioned as in the first example embodiment of FIG. 1. When a stress of 10N was applied to a single axis, a change in curvature of a fillet and a change in stress applied to an external electrode were simulated according to a change in a radius of the protrusion portion.

TABLE 1

| | Radius of | Volume of Four | Maximum Stress |
|---|---|---|---|
| Experimental | Protruding | Protruding | (Value Relative |
| Examples | Portion | Portions | To (A)) |
| (a) | — | — | 0% |
| (b) | — | — | −63.9% |
| (c) | 0.25 mm | 0.129 mm³ | −73.9% |
| (d) | 0.39 mm | 0.516 mm³ | −78.0% |
| (e) | 0.52 mm | 1.162 mm³ | −83.0% |
| (f) | 0.63 mm | 2.062 mm³ | −86.9% |

Referring to Table 1 and FIG. 23, a stress relaxation effect was confirmed through a simulation based on a relative value of maximum stress applied to an external electrode in case (a), in which only a lower surface of the external electrode was fixed. In case (b), in which only a fillet was formed by solder without a protrusion portion, a stress relaxation of −63.9% was measured. In cases (c) to (f), four protrusion portions were formed on each of left and right external electrodes. As a radius of each of the protrusion portions increased, a Sn volume in the protrusion portion, capable of reinforcing a fillet, also increased. Consequently, a maximum height of the fillet and a curvature of an inclined surface increased (R1<R2<R3<R4), and an improvement in a maximum stress relaxation effect was also observed.

While some example embodiments have been shown and described above, it will be apparent to those skilled in the art that modifications and variations could be made without departing from the scope of the present disclosure as defined by the appended claims.

What is claimed is:

1. A coil component comprising:
a body including a first surface and a second surface opposing each other in a first direction, and a third surface and a fourth surface opposing each other in a second direction, perpendicular to the first direction;
a coil including a winding portion embedded in the body, and a lead-out portion extending from an end of the winding portion onto outside surface of the body in the first direction; and
an external electrode disposed on the body, the external electrode having an internal surface facing the body and an external surface opposing the internal surface,
wherein the external electrode includes at least one protrusion portion protruding from the internal surface toward the body, and the lead-out portion is in contact with the internal surface of the external electrode.

2. The coil component of claim 1, wherein the external surface of the external electrode has a flat shape.

3. The coil component of claim 2, wherein
the external electrode includes a first metal layer disposed on the body, and a second metal layer disposed on the first metal layer, and
the protrusion portion includes the first metal layer protruding toward the body, and the second metal layer filling a recessed region formed in an external surface of the first metal layer.

4. The coil component of claim 3, wherein the second metal layer includes Sn.

5. The coil component of claim 1, wherein the external electrode includes a base portion disposed on the first surface or the second surface, an insertion portion bent from the base portion toward an inside of the body, the insertion portion having at least a portion disposed in the body, and a pad portion bent from the base portion such that to be disposed on a part of the third surface of the body.

6. The coil component of claim 5, wherein the protrusion portion is disposed on at least one of the base portion or the pad portion.

7. The coil component of claim 6, wherein the external electrode includes more than one protrusion portion, and the more than one of the protrusion portions are disposed on the base portion.

8. The coil component of claim 6, wherein the external electrode includes more than one of the protrusion portion, and the more than one of the portions are disposed on the pad portion.

9. The coil component of claim 1, wherein
the external electrode includes more than one protrusion portion, and
the lead-out portion is disposed between at least one pair of protrusion portions.

10. The coil component of claim 9, wherein
the pair of protrusion portions are disposed in parallel in a third direction, perpendicular to the first direction and the second direction, respectively, and
a minimum distance between the pair of protrusion portions is greater than a maximum line width in the third direction of the lead-out portion.

11. The coil component of claim 9, wherein heights of the pair of protrusion portions are substantially the same.

12. The coil component of claim 1, wherein the protrusion portion has a cross-section having a semicircular, arch, tapered, triangular, or quadrilateral shape.

13. The coil component of claim 1, wherein the lead-out portion extends from the end of the winding portion in the first direction to be closer to the fourth surface than the third surface, on the first surface or the second surface.

14. The coil component of claim 1, wherein the lead-out portion extends from the end of the winding portion in the first direction to be closer to the third surface than the fourth surface, or into a central region of the first surface or the second surface in the second direction.

15. The coil component of claim 1, wherein
the coil includes a plurality of lead-out portions including a first lead-out portion and a second lead-out portion,
the first lead-out portion extends along and is disposed on the first surface,
the second lead-out portion extending along and is disposed on the second surface, and
at least a portion of each of the first lead-out portion and the second lead-out portion extends to and is disposed on the third surface.

16. A coil component comprising:
a body;
a coil embedded in the body, the coil including a lead-out portion; and
an external electrode disposed on the body, the external electrode connected to the lead-out portion, the external electrode including a plurality of protrusion portions,
wherein the lead-out portion is disposed between at least two of the plurality of protrusion portions adjacent to each other.

17. The coil component of claim 16, wherein the at least two of the plurality of protrusion portions adjacent to each other disposed in a direction perpendicular to a direction in which the lead-out portion extends on the body.

18. The coil component of claim 16, wherein an even number of the protrusion portions are formed.

19. The coil component of claim 16, wherein a thickness of the lead-out portion is less than or equal to a thickness of a protruding region of the protrusion portion.

20. A coil component comprising:
a body including a first surface and a second surface opposing each other in a first direction, and a third surface and a fourth surface opposing each other in a second direction, perpendicular to the first direction;
a coil including a winding portion embedded in the body, and a lead-out portion extending from an end of the winding portion onto outside surface of the body in the first direction; and
an external electrode disposed on the body and a part of the lead-out portion disposed on the body such that the part of the lead-out portion is interposed between the external electrode the first or second surface of the body.
